(19) United States
(12) Patent Application Publication
(10) Pub. No.: US 2009/0284746 A1
(43) Pub. Date: Nov. 19, 2009

(54) RADIATION DETECTORS USING EVANESCENT FIELD EXCITATION

(75) Inventors: Derk Jan Wilfred Klunder, Eindhoven (NL); Maarten Marinus Johannes Wilhelm Van Herpen, Eindhoven (NL); Marcello Leonardo Mario Balistreri, Eindhoven (NL); Marc Wilhelmus Gijsbert Ponjee, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/373,995

(22) PCT Filed: Jul. 4, 2007
(86) PCT No.: PCT/IB2007/052612

§ 371 Date: Jan. 15, 2009

(30) Foreign Application Priority Data
Jul. 20, 2006 (EP) 06117538.6

(51) Int. Cl. G01N 21/55; G01N 21/62

(52) U.S. Cl. 356/445

(57) ABSTRACT

A detection system (100, 150, 180, 200, 220, 250) for detecting luminescence from at least one sample (108) when excited by incident excitation radiation. Detecting luminescence may allow to detect, for example, biological, chemical or bio-chemical particles. The detection system (100, 150, 180, 200, 220, 250) comprising at least one optical component (102) with at least a first surface (104). The first surface (104) of the at least one optical component (102) is located to internally reflect incident excitation radiation to create an evanescent field outside the at least one optical component (102) for exciting the at least one sample (108). The detection system also comprises at least one detector element (110) that is in direct contact with the at least one optical component (102) to detect the luminescence from at least one excited sample (108) through the at least one optical component (102).

The present invention relates to radiation detection, e.g. for sensing biological, chemical or bio-chemical particles. More particularly, the present invention relates to methods and systems for detecting luminescence from a sample and to corresponding methods of manufacturing such devices.

Micro-fluidic devices are at the heart of most biochip technologies, being used for both the preparation of fluidic, e.g. blood based, samples and their subsequent analysis. Integrated devices comprising biosensors and micro-fluidic devices are known, e.g. under the name DNA/RNA chips, BioChips, GeneChips and Lab-on-a-chip. In particular, high throughput screening on arrays, e.g. micro-arrays, is one of the new tools for chemical or biochemical analysis, for instance employed in diagnostics. These biochip devices comprise small volume wells or reactors, in which chemical or biochemical reactions are examined, and may regulate, transport, mix and store minute quantities of liquids rapidly and reliably to carry out desired physical, chemical, and biochemical reactions and analysis in large numbers. By carrying out assays in small volumes, significant savings can be achieved in time and in costs of targets, compounds and reagents.

Generally, detection of fluorescence signals of a biochip is done using an optical detection system, comprising a light-source, optical filters and sensors (e.g. CCD camera), localized in a bench-top/laboratory machine, to quantify the amount of fluorophores present. One of the main sources of noise in a fluorescence based optical system typically is excitation irradiation being incident on the detector used for detecting fluorescence. Typically, filters for separating excitation radiation and luminescence radiation are used, but these have the disadvantage of being of high economical cost and typically require a labour intensive manufacturing. The latter is especially the case if the shift between the excitation spectrum (absorption) and luminescence spectrum (fluorescence) is small (<50 nm).

In many biotechnological applications, such as molecular diagnostics, there is a need for biochips comprising an optical sensor, or an array of optical sensors, that detect fluorescence signals and can be read-out in parallel and independently to allow high throughput analysis under a variety of (reaction) conditions. Advantages of biochips incorporating the optical sensor are, among others that an on-chip fluorescence signal acquisition system improves both the speed and the reliability of analysis chips, e.g. DNA chip hybridization pattern analysis, that costs are reduced for assays and that high portability is obtained e.g. by obtaining portable hand-held instruments for applications such as point-of-care diagnostics and roadside testing (i.e. no central bench-top machine needed anymore).

A bench-top machine will become able to handle versatile biochips and a multiplicity of biochips. Having the optical sensor as part of the bench-top machine demands the mounting of a specific filter set for a specific assay, which hampers the parallel (multiplexed) detection of fluorescent labels with various excitation and/or emission spectra. Therefore, being able to read-out on-chip optical sensor(s) allows for a flexible multi-purpose bench-top machine and opens the route towards standardization of biochips, bench-top machines, and components thereof. Nevertheless, the need for filters makes such biochips expensive, which is especially disadvantageous if disposable biochips are considered.

In numerous biotechnological applications, such as molecular diagnostics, there is a need for biochemical modules (e.g. sensors, PCR), comprising an array of temperature controlled compartments that can be processed in parallel and independently to allow high versatility and high throughput.

Biosensors are known wherein evanescent field excitation is performed. In a medium with no absorption, i.e. with a purely real refractive index, an electromagnetic wave is evanescent in a particular direction when it maintains a constant phase in that direction but has exponentially decreasing amplitude. In biosensors, e.g. use is made of total internal reflection, wherein an excitation beam is totally internally reflected at a surface to which sample particles are attached. At the point of reflection, an evanescent wave is generated with a characteristic decay depth typically of one optical wavelength. Therefore, at the reflecting surface, the light is confined to the surface and it interacts preferentially with sample particles within the decay depth of the surface. An advantage of the excitation of fluorescence using evanescent fields over using propagating fields is the reduction in the excitation volume and the resulting improvement in the fluorescent signal over fluorescent background. A disadvantage of evanescent field excitation is that the excitation scheme is less straightforward than excitation with propagating light, as it requires the incident beam to have an angle larger than the total internal reflection angle at the interface with the sample or the use of more sophisticated structures for converting a propagating beam into an evanescent field.

US patent application 20030205681 shows a method for detecting luminescence emitted by a sample using a micro plate having a plurality of sample wells. By directing excitation light through a bottom outer surface so that it impinges on a bottom inner surface at an angle sufficient for total internal reflection, an evanescent field is created in the sample well. A detector is positioned above the sample well so that it may detect luminescence emitted by the sample. The detector can be positioned so that it detects luminescence emitted normal to the inner surface or to detect luminescence emitted in other directions, including perpendicular to normal or other angles so that the angle between incident excitation light and detected luminescence light is substantially different than 0, 90, or 180 degrees.

It is an object of the present invention to provide good methods and systems for detecting biological, chemical or bio-chemical analytes, e.g. in the form of particles. More particularly, efficient detection methods and systems are provided as well as methods of manufacturing such devices.

The above objective is accomplished by a method and device according to the present invention.

The invention relates to a detection system for detecting luminescence from at least one sample when excited by incident excitation radiation, the detection system comprising at least one optical component with at least a first surface and at least one detector element, wherein the first surface of the at least one optical component is located to totally internally reflect incident excitation radiation to create an evanescent field outside the at least one optical component for exciting the at least one sample, and the at least one detector element is in direct contact with the at least one optical component to detect the luminescence from at least one excited sample through the at least one optical component. It is an advantage of embodiments of the present invention that an efficient detection system is obtained. It is an advantage of embodiments of the present invention that the amount of luminescence captured in the at least one optical component and not reaching the detector is low. It is also an advantage of embodiments of the invention that, depending on the refractive index difference of the at least one optical component with the surroundings, much of the luminescence emissions enters the at least one optical component. The detector element being in direct contact with the optical component may be in direct contact with a second surface of the optical component. In direct contact with the optical component may be such that no layer with low index of refraction, e.g. air layer is present between the at least one optical component and the at least one detector element. The evanescent field may be created by total internal reflection of the excitation radiation in the optical component. Placing the at least one detector element in contact with the optical component may allow to obtain a more robust device and improves the ease of manufacturing. Furthermore it may reduce the amounts of losses occurring.

The at least one optical component may be a prism. It is an advantage of embodiments of the present invention that the system may be adapted to predetermined excitation and luminescence radiation used by selecting the material of the optical component as function of its refractive index for the excitation and luminescence radiation wavelength used.

The at least one detector element may be in direct contact with a second surface of the at least one optical component, the angle between the first surface and the second surface of the at least one optical component being adapted to a dominant luminescence radiation direction of the radiation of the at least one sample coupled in into the optical component as to receive a substantial part of the luminescence of the at least one sample entered in the at least one optical component in the detector element. The receiving may be directly receiving. Directly receiving in the detector may be receiving the luminescence without additional reflection in the at least one optical component. A substantial part of the luminescence of the at least one sample entered in the at least one optical component may be at least 40% of the luminescence entered in the at least one the optical component, preferably at least 45% of the luminescence entered in the at least one optical component, more preferably at least 50% of the luminescence entered in the at least one optical component.

The emission pattern of the at least one sample is such that a substantial part of the luminescence is emitted under substantially an angle α with respect to the normal to the first surface, the second surface of the at least one optical component making an angle with the first surface that is larger than the angle α.

The angle between the second surface and the first surface may be e.g. between 5° and 35° larger, e.g. between 10° and 30° larger, e.g. about 20° larger than the angle α.

The second surface may be the surface through which the excitation radiation is coupled into the optical component. The at least one optical component may be arranged with respect to the sample and consists of a material having a refractive index such that more than 50% of the luminescence to be coupled into the at least one optical component. It is an advantage of particular embodiments of the present invention that through an appropriate shape and material selection of the at least one optical component, the amount of luminescence coupled into the at least one optical component can be optimized.

The at least one detector may comprise an array of detector elements. This can enable multiple samples to be tested, with less or no need for scanning of a focused illumination source. The array of detector elements may be a single pixelated detector or may be a plurality of separate detector elements. It is an advantage of particular embodiments of the present invention that using an array of detector elements may allow to increase the spatial resolution. The latter may be obtained by taken into account the specific emission pattern of the at least one sample to be detected for positioning the detector and for shaping the at least one optical component.

The at least one optical component may comprise a plurality of optical components, each of the plurality of optical components adapted for receiving luminescence of at least one sample. The plurality of optical components may be a plurality of prisms. The detection system may comprise a single, e.g. pixelated, detector in direct contact with each of the plurality of optical components. The detection system furthermore may comprise a separate detector element for each of the plurality of optical components.

The plurality of optical components may be arranged such that a surface of each of the optical components is parallel to a same plane and such that the optical components receive the excitation radiation substantially perpendicular to the plane. It is an advantage of particular embodiments of the present invention that simultaneous and/or uniform irradiation with excitation radiation may be obtained.

The at least one detector element may comprise a plurality of detector elements, a detection surface thereof being parallel to a same plane and being at a same side of the optical components as a side from which the excitation radiation is received in the optical components. The plane to which the detection surfaces of the plurality of detector elements are parallel may be the same plane as the plane to which a surface of each of a plurality of optical components are parallel. It is an advantage of particular embodiments of the present invention that the position of the detector elements may be such that separating excitation radiation and luminescence radiation can be performed substantially easy, resulting in a low signal/noise ratio.

The detection system furthermore may comprise a surface adapted for reflecting luminescence from the at least one excited sample coupled in the optical component towards the at least one detector element. The latter may allow to further increase the detection efficiency.

The detection system may comprise furthermore a reflector to reflect the incident illumination after it has passed through the optical component, back into the optical component. The latter may allow to further increase the detection efficiency.

The detection system may be an integrated device based on large-area electronics technologies. It is an advantage of particular embodiments of the present invention that an easy manufacturing of different components may be obtained, e.g. based on integrated circuit technology or active matrix technology.

The detection system furthermore may comprise an irradiation source for generating excitation radiation.

The detection system may comprise a means for focusing and a means for scanning the excitation radiation from the irradiation source.

The present invention also relates to a method for detecting luminescence from at least one sample, the method comprising, providing at least one sample to an external surface of at least one optical component, creating an evanescent excitation field outside the at least one optical component near the external surface to excite the at least one sample, detecting luminescence from the at least one sample coupled in the at least one optical component and collected in at least one detector element in direct contact with the optical component.

Collecting the luminescence in at least one detector element may comprise collecting the luminescence at a position adapted to a dominant emission direction of radiation of the at least one sample coupled into the optical component.

The present invention furthermore relates to a method for manufacturing a detection system, the method comprising providing at least one optical component having a first surface adapted for binding particles thereto and providing at least one detector element in direct contact with the at least one optical component.

Providing at least one detector element may comprise creating at least one detector element in a substrate using large-area electronics technologies.

Particular and preferred aspects of the invention are set out in the accompanying independent and dependent claims. Features from the dependent claims may be combined with features of the independent claims and with features of other dependent claims as appropriate and not merely as explicitly set out in the claims.

The teachings of the present invention permit the design of efficient methods and apparatus for detecting chemical, biological or bio-chemical analytes, e.g. in the form of particles.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

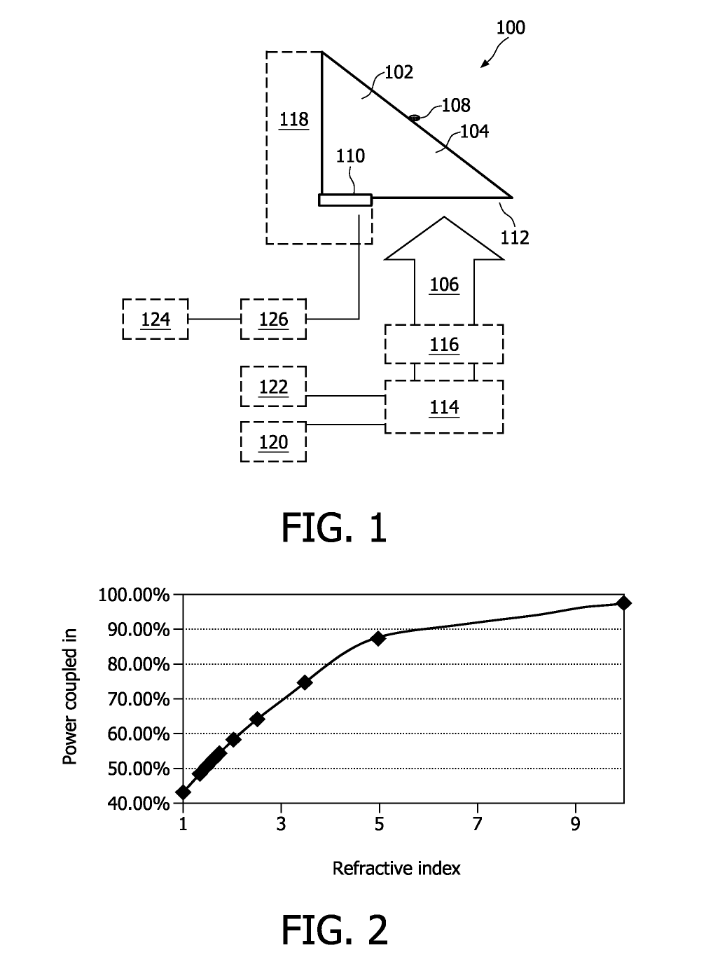

FIG. 1 illustrates a schematic representation of a detection system for illustrating a detection system according to embodiments of the first aspect of the present invention.

FIG. 2 shows a graph of the fraction power radiated into an optical component as function of the refractive index of the optical component for a dipole that is parallel with the interface between the optical component and its environment.

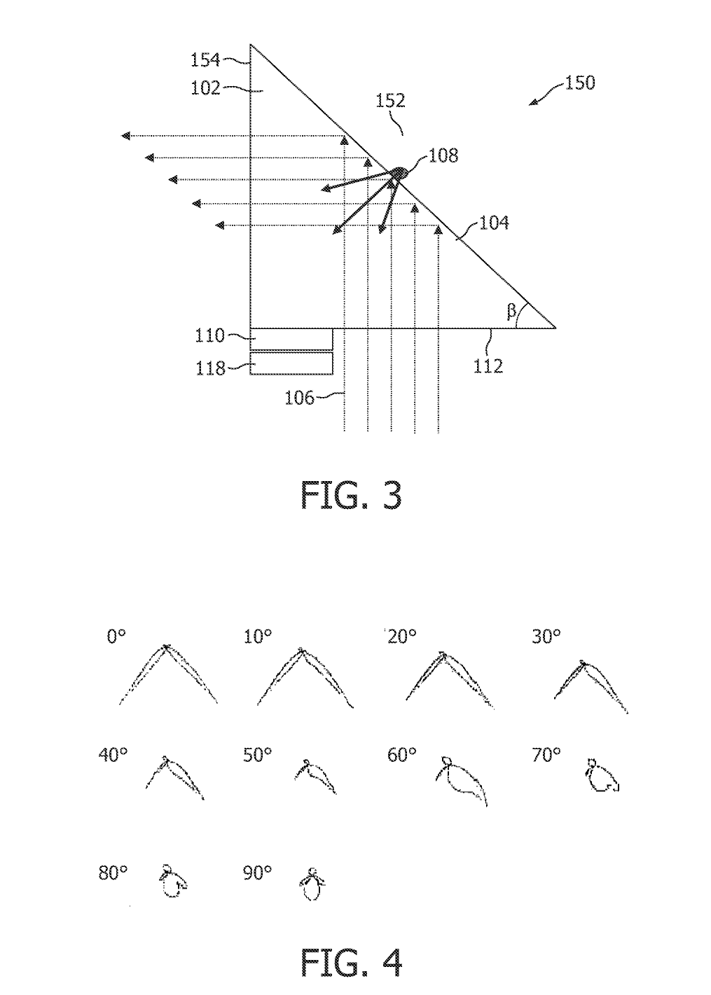

FIG. 3 is a schematic representation of a detection system comprising detection through a single optical component according to a first embodiment of the present invention.

FIG. 4 illustrates schematically far field angular distribution of the emission/power for different angles of orientation of an emitting dipole sample, as can be used in particular embodiments according to the present invention.

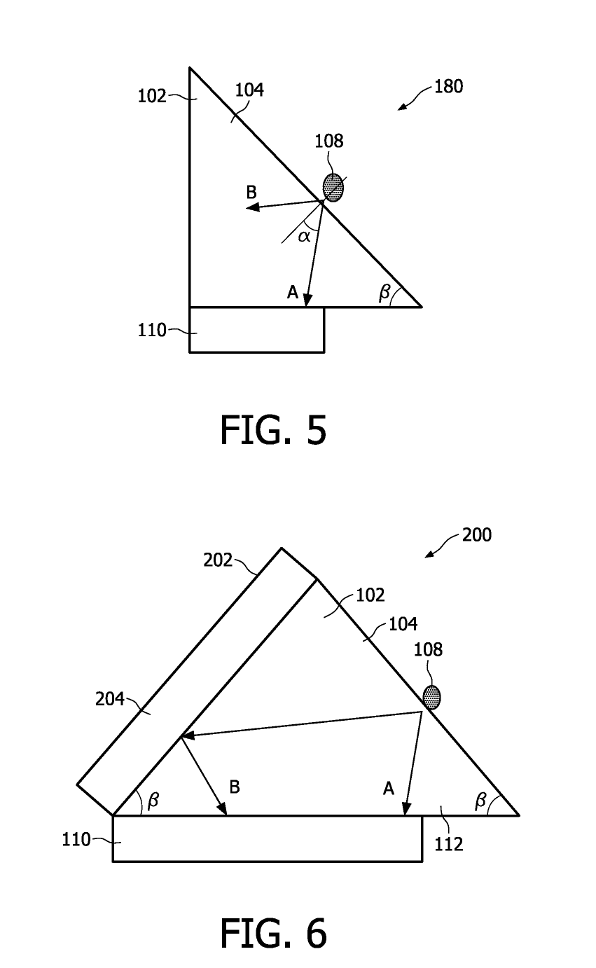

FIG. 5 is a schematic representation of a detection system with improved detection efficiency according to the second embodiment of the present invention.

FIG. 6 is a schematic representation of a detection system comprising a reflector for luminescence according to a third embodiment of the present invention.

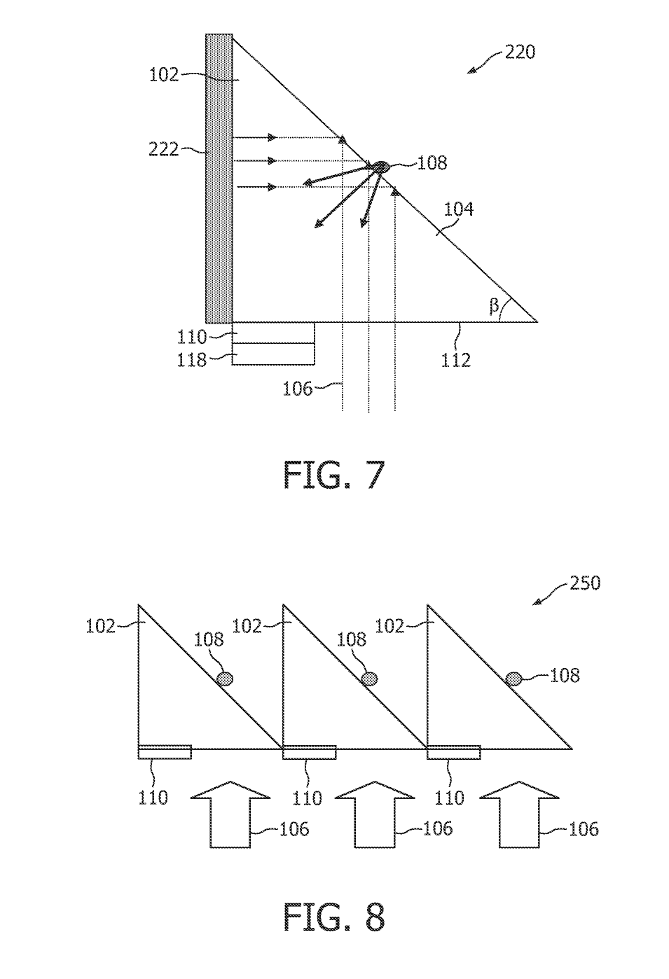

FIG. 7 is a schematic representation of a detection system comprising a reflector for excitation radiation according to a third embodiment of the present invention.

FIG. 8 is a schematic representation of a detection system comprising a plurality of detector elements according to a third embodiment of the present invention.

In the different figures, the same reference signs refer to the same or analogous elements.

The present invention will be described with respect to particular embodiments and with reference to certain drawings but the invention is not limited thereto but only by the claims. Any reference signs in the claims shall not be construed as limiting the scope. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, base and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

The following terms or definitions are provided solely to aid in the understanding of the invention. These definitions should not be construed to have a scope less than understood by a person of ordinary skill in the art. Incident radiation is intended to encompass any kind of electromagnetic radiation including UV, visible light and IR, amongst others. Luminescence and emissions is intended to encompass any electromagnetic radiation including amongst others fluorescence, Raman scatter, and other emissions, typically generated in response to an excitation source. Integrated device is intended to encompass amongst others integration of any type including devices formed by integrated semiconductor processes, or devices such as hybrids formed by integrating previously manufactured parts by attaching by solder, glue or any other means. Integrated detector is intended to encompass amongst others integration of any type including detector elements formed on the device by integrated semiconductor processes, or detector elements previously manufactured then attached by solder, glue or any other means.

In the present invention, devices and methods for sensing typically are adapted for sensing irradiation. Such irradiation may stem from a surface or from anywhere in a volume such as in a liquid, e.g. immobilized particles on a surface as well as from non-immobilized probes, e.g. present in a liquid sample and not bounded to a surface. The devices and methods for sensing thus may be adapted for sensing or quantifying any of chemical, bio-chemical or biological analytes, e.g. in the form of particles. Such sensors may e.g. be used for real-time polymerase chain reaction (PCR). In real-time PCR, fluorescently labeled probes or DNA binding fluorescent dyes are used for detection and quantification of a PCR product, thus allowing quantitative PCR to be performed in real time. Whereas DNA binding dyes do not allow differentiation between specific and non-specific PCR products, fluorescently labeled nucleic acid probes have the advantage that they react with only specific PCR products. In case of real-time PCR typically a PCR primer starts to irradiate once it binds to a signal molecule. The latter typically may occur in a sample, without being bound to sites on a surface or substrate. Alternatively, in other applications such as other fluorescence based sensing and/or quantification techniques, the probes can be immobilized or attached to the sites by non-covalent or covalent bonding.

Real-time PCR can be advantageously employed in implementations of the present invention, though many other test methods can be used. Real-time PCR as well as rapid cycle real-time PCR is described in “Rapid cycle real-time PCR”, Reischl, Wittwer, Cockerill, Springer Verlag, 2001, especially in the chapter entitled: “Applications and Challenges of Real-Time PCR for the Clinical Microbiology Laboratory”. Other applications for the devices can include any type of luminescence assays, including intensity, polarization, and luminescence lifetime. Such assays may be used to characterize cell-substrate contact regions, surface binding equilibriums, surface orientation distributions, surface diffusion coefficients, and surface binding kinetic rates, among others. Such assays also may be used to look at proteins, including enzymes such as proteases, kinases, and phosphatases, as well as nucleic acids, including nucleic acids having polymorphisms such as single nucleotide polymorphisms (SNPs), ligand binding assays based on targets (molecules or living cells) situated at a surface. Other examples include functional assays on living cells at a surface, such as reporter-gene assays and assays for signal-transduction species such as intracellular calcium ion. Still other examples include enzyme assays, particularly where the enzyme acts on a surface-bound or immobilized species.

The probes can be any suitable molecule or molecules, e.g. antibodies or binding fragments thereof, DNA or RNA, fragments of DNA or RNA, peptides, proteins, carbohydrates, cells, cell parts such as external or internal cell membranes or organelles, bacteria, viruses, etc. Also the probes may include combinations of these, e.g. cell proteins. If immobilization of the probes is used in the sensing device or method, the surface of sites for the probes may be treated to obtain useful properties to allow immobilization of the samples, e.g. the site surface may be made hydrophobic or hydrophilic. Typically such sites may be created by depositing or printing biomolecules as spots, such that when the spots are dried, the spot is in direct contact or aligned with the radiation detector. The biomolecules are preferably probes which bind to an analyte molecule whose presence is intended to be determined. General methods of attaching biological molecular probes to the surface of substrates are known the skilled person—see for example “Micorarray Technology and Its Application”, Müller and Nicolau, Springer, 2005, chapters 2 and 3. The spot area or probe site can be called a “pixel”. Spot deposition can be done by any suitable technique, e.g. contact or non-contact printing, micro spotting, solid or split pin or quill printing, pipetting or thermal, solenoid or piezoelectric ink-jet printing of liquid samples, e.g. in the form of biomolecules. In accordance with embodiments of the present invention, probes adapted for irradiating typically are aligned with an array of a number of radiation detector sites. Sample comprising probes may be aligned with an array of a number of radiation detector sites and/or an array of a number of sites at which probes may be immobilized may be aligned with the array of radiation detector sites.

Analyte molecules can be any molecules which need to be detected, e.g. DNA or RNA, fragments of DNA or RNA, peptides, proteins, carbohydrates, cells, cell parts such as external or internal cell membranes or organelles, bacteria, viruses, etc. To allow luminescence of the bound probes and analyte molecules, the probes and/or the analyte molecules can comprise or be attached to labels which provide the luminescence, e.g. by fluorescence, phosphorescence, electroluminescence, chemiluminescence, etc. When labeled, the probes or analyte molecules may be described as “variable optical molecules”. Once bound the light emission from the irradiating probe changes, e.g. it may emit chemiluminesce or it may emit fluorescence if excited with radiation of the correct wavelength. Other forms of light emission can be used, e.g. electroluminescence, with the present invention, e.g. by provision of the appropriate stimulant such as an electric current.

The exposing of the sample can be carried out manually or can be automated e.g. by means of MEMS devices or micro valves for driving fluids along micro channels into and out of the site. If needed, the temperature of the fluids and the site can be controlled precisely by resistors.

In a first aspect, the present invention relates to a system for detecting biological, chemical and/or bio-chemical analytes, e.g. in the form of particles. The detection system thereby is adapted to generate an evanescent excitation field for exciting luminescent particles, e.g. target particles labeled with fluorescent labels, and for detecting the luminescence through the optical component used for generating the evanescent excitation field in a detector element. A schematic representation of a detection system according to the first aspect, indicating a number of essential and optional parts is indicated in FIG. 1. The detection system 100 according to the first aspect of the present invention typically comprises at least one optical component 102. The at least one optical component 102 typically comprises a first surface 104 and is oriented such that an incident excitation radiation beam 106 undergoes total internal reflection at the first surface 104 such that an evanescent field is created outside the at least one optical component 102. In other words, the optical component 102 typically is adapted for receiving an incident excitation radiation beam 106 and for providing total internal reflection of the excitation radiation beam 106 at the first surface 104 of the at least one optical component 102, thus creating an evanescent field near the first surface 104 outside the at least one optical component 102. This evanescent field typically is used for exciting at least one sample 108. Using evanescent field excitation has the advantage over using propagating field excitation in that it reduces the excitation volume, resulting in an improvement of the signal to background ratio for the detected luminescence response, e.g. fluorescent signal.

The detection system 100, or more particularly the at least one optical component 102 therefore may be adapted to accommodate sample 108 nearby the first surface 104. The first surface 104 may e.g. be adapted with for binding sample 108, e.g. target particles that are luminescent, e.g. by being labeled by fluorescent labels, or luminescent particles may be e.g. non-bounded sample 108 particles in a fluid brought in close proximity to the first surface 104, e.g. preferably at a distance not further than the excitation wavelength away, more preferably not further than ⅓ of the excitation wavelength away from the first surface 104. The depth of the evanescent field can be altered for example by coating the interface with a suitable material, such as a thin metal film.

The at least one optical component 102 typically may be a prism. The at least one optical component 102 typically may be made of material substantially transparent for the excitation radiation beam 106 used in the detection system 100 and also substantially transparent for the luminescence response of the at least one sample 108 excited using the evanescent excitation field. For a plurality of assays performed today, such material may e.g. be glass, fused silica, or plastic. The optical component 102 may be any optical component with a shape such that the incident light, i.e. excitation radiation beam 106, is completely totally internally reflected. The latter may also comprise e.g. prisms with a polygonal shape. Typically the detection system 100 furthermore comprises at least one detector element 110. The at least one detector element 110 is positioned in direct contact with the optical component 102, e.g. in direct contact with a surface 112 of the optical component 102. With positioned in direct contact with the optical component 102 there may be meant that no layer with low index of refraction, e.g. an air layer, is present between the at least one optical component 102 and the at least one detector element 110. Typically in the present application a material is considered to have a low index of refraction if the index of refraction is smaller than 1.4, e.g. smaller than 1.33. In order to avoid substantial total internal reflection at the interface between the at least one optical component 102 and the at least one detector element 110, the layer in between the at least one optical component 102 and the at least one detector element 110, if present, should have an index of refraction that is not substantially lower than the index of refraction of the at least one optical component 102. The detector element 110 may e.g. be in direct contact with the optical component by a transparent glue having a refractive index that is sufficiently high such that the luminescence to be detected is not substantially totally internally reflected. The direct contact between the detector element 110 and the optical component 102 may, although less preferable from practical point of view, also be obtained using an index matching fluid. The at least one detector element 110 may be any detector element suitable for detecting electromagnetic radiation emitted by the at least one sample. The detector element may for example be a photo-detector like a diode, a pixelated detector such as e.g. a row detector or m×n 2-dimensional detector, a row of photo-detectors, . . . In the detection system 100 according to the first aspect of the present invention, detection of luminescence of the sample thus is done through the at least one optical component 102. Detecting through the prism also largely solves the issue discussed above of reflections and other losses in the detection path. The influence of the material selection of the at least one optical component 102 may strongly influence the amount of luminescence radiation that is coupled into the at least one optical component 102 and that thus the amount of luminescence radiation that will be available for detection. FIG. 2 shows that increasing the index of the optical component that binds the particle, e.g. labeled target particle corresponding with a dipole emitter, can provide an increase of the fractional power coupled into the optical component 102 well above 50%. In FIG. 2, the luminescence coupled in from an in-plane oriented dipole 1 nm above the optical component 102 and surrounded by water is shown by way of example. The results shown by way of illustration, are based on calculations performed with a finite element method for a wavelength of 600 nm.

An advantage obtained by positioning the detector element 110 in direct contact with the optical component 102 is that the amount of luminescence coupled out from the optical component 102 to the detector element 110 is substantially high as a large total internal reflection angle typically is present at the optical component/detector surface. The angle for total internal reflection typically is larger than, e.g. if an optical component/air surface is present, which leads to less luminescence light being captured by total internal reflection in the optical component 102 and thus more light being coupled out to the detector element 110. The latter thus results in a higher detection efficiency than would be the case when a low refractive index layer, e.g. air layer, would be between the detector element 110 and the at least one optical component 102.

The detection system 100 furthermore typically may comprise an irradiation source 114 for generating the excitation radiation beam 106. The irradiation source 114 may generate any electromagnetic radiation allowing to excite the sample 108. The irradiation source 114 may be e.g. a light emission diode, a laser, or any other suitable irradiation source. The irradiation source 114 may be part of the detection system 100 or may be external to the detection system 100. Both wide field excitation and excitation by a focused/narrow beam using a scanning beam technique. Excitation by a focused/narrow beam has the advantage of a reduced excitation volume and thus improved SNR. A possible arrangement may e.g. be 2D array of optical components, with a matched array of excitation spots/sources. By translating the array, one can probe the different prisms, e.g. with different adhesion layers or adapted for binding other target particles in parallel. The latter allows a type of multiplexing.

The detection system 100 furthermore optionally also may comprise first additional optical components 116 for guiding, focusing and/or filtering the excitation radiation beam. Typically such additional optical components 116 may be lenses, mirrors and/or dichroic filters. The detection system 100 also may comprise second additional optical components 118 in direct contact with the optical component 102 or in contact with the at least one detector element 110. The second additional optical components 118 may for example comprise shielding elements for shielding the detector element 110 from direct incidence from excitation radiation. The second additional optical components 118 also may comprise for example reflecting elements for additionally guiding luminescence to the detector element 110 or dichroic filters for splitting the excitation radiation from the generated luminescence coupled into the optical component 102.

The detection system 100 furthermore may optionally also comprise a focusing means 120 for focusing the excitation radiation beam 106 and a scanning means 122 for scanning the excitation radiation beam 106. In embodiments according to the first aspect of the present invention, detection either may be performed by scanning the excitation radiation beam 106 or a wide area excitation may be performed.

The detection system 100 furthermore also may comprise a control and analysis circuitry 124 which may be implemented in any suitable manner, e.g. via dedicated hardware or software. It may e.g. be a suitably programmed computer, microcontroller or embedded processor such as a microprocessor, programmable gate array such as a PAL, PLA or FPGA, or similar. The control and analysis circuitry may provide output to an output device 124.

Although in particular embodiments of the present invention large area scanning using a focused beam and multi-spot excitation may be performed, the spatial resolution of the present technique also may be inherently increased based on spatial distinctive detection of different luminescent particles at different positions of the first surface of the at least one optical component. Typically use thereby may be made of a predetermined emission pattern of the luminescent particles emitting luminescent radiation in specific directions.

The excitation area at the interface between the optical component(s) and the medium that surround the luminescent particles is limited by the size of the prism and the part that is blocked by detector(s). In case of a large prism on top of a discrete array of detectors, each detector is aligned with a certain area of the interface between the medium and the prism. An alternative arrangement involves an array of prisms on top of a discrete array of detectors so that each prism has a dedicated detector. In both cases one can do a spatially resolved measurement of the fluorescence, where the dimensions of the detectors or the dimensions of the prisms limit the spatial resolution. It should be remarked that the spatial resolution is well above the diffraction limit and rather in the order of 1.0-100 microns.

The first aspect of the present invention will be further illustrated, by way of example, by a number of embodiments, the present invention not being limited thereto.

In a first embodiment according to the first aspect, the present invention relates to a detection system 100 as described above, wherein the at least one optical component 102 is a single optical component 102, e.g. a single prism. The detection system 100 also comprises a single detector element 110 in contact with the single optical component 102, such that detection of luminescence through the optical component 102 is used. The optical component thereby is at least partly positioned on top of the detector element 110. Such a detector element 110 may be a pixelated detector. A schematic representation of an exemplary detection system 150 according to the present embodiment is shown in FIG. 3. The exemplary detection system 150 shown in FIG. 3 is illuminated with excitation radiation from the bottom via a second surface 112, e.g. the base, of the optical component 102, e.g. prism, and essentially perpendicular to the second surface 112, e.g. base. It is to be noted that the direction of incidence of the excitation radiation is not limited to a direction essentially perpendicular to the second surface 112, and that other directions of incidence also may be used. The detector element 110 is located on the same side of the optical component 102, but shifted in position such that the excitation radiation passes the detector element 110. In other words, the detector element 110 is also positioned at the second surface 112, e.g. base side, of the optical component 102, e.g. prism. The detector element 110 is shielded from below in order to avoid excitation radiation being detected directly by the detector element 110, i.e. without entering the optical component 102. The angle β of the first surface 104 of the prism to its second surface 112, e.g. base, typically may be chosen larger than the critical angle for the interface between the optical component 102 and the medium 152, such that excitation radiation normal incident at the second surface 112, e.g. base, of the optical component 102, e.g. prism, is totally internally reflected at the optical component 102/medium 152 interface, i.e. in order to create evanescent field excitation near the optical component 102/medium 152 interface. In the present example, wherein an optical component 102 with a refractive index larger than 1.881 and a medium 152 with a refractive of 1.33 are assumed, the critical angle of total internal reflection (i.e., the minimum angle required for total internal reflection to occur) at the first surface 104 is larger than 45 degrees. As a consequence, the angle β between the second surface 112 and the first surface 104 can be set approximately 45°, which results in totally internally reflected excitation radiation that passes substantially parallel to the second surface 112. It is to be noticed that the latter is case specific and depends on the index of refraction of the optical component 102. The excitation radiation is thus coupled out of the optical component 102 at a third surface 154. Of course the prism can have other surfaces and shapes. In case of a luminescent sample particle 108, e.g. also referred to as luminophore/bead, is in the neighborhood of the optical component 102/medium 152 interface, e.g. in case a luminescent sample particles is bound to the first surface, it experiences an evanescent field. The resulting fluorescence is radiated into both the optical component 102 and the medium 152. By a proper choice of the refractive index of the optical component 102, as illustrated in FIG. 2, more power is radiated into the optical component 102, e.g. prism, than into the medium 152.

In a second embodiment of the first aspect, the present invention relates to a detection system as described above, e.g. as described—but not limited thereto—in the first embodiment, comprising the same features and the same advantages, but wherein furthermore the angle between the first surface 104 and the second surface 112 of the at least one optical component 102 is adapted to where most of the radiation of the luminescent particles is directed in the optical component 102. By way of example, the invention not limited thereto, the luminescent particles may be considered as dipole radiators. A typical emission pattern of such dipole radiators is shown in FIG. 4, illustrating polar plots of the far field angular distribution of the power for dipole emission for an out-of-plane orientation of the dipole radiation (indicated by 0°) whereby the radiation is concentrated away from the normal of the interface, i.e. with side lobes at large angles, e.g. typically around the critical angle. For in-plane orientation of the dipole radiation (indicated by 90°), the radiation is concentrated more around the normal of the interface.

By a proper choice of the angle β between the first surface 104 and the second surface 112, radiation at angles somewhat larger than the critical angle of the optical component 102/medium 152 interface has an orientation essentially parallel with the second surface 112 or essentially normal with the second surface 112. The radiation angles thereby are expressed with respect to the normal of the optical component 102/medium 152 interface. Such a proper choice may be selecting the angle between the first surface 104 and the second surface 112 of the optical component somewhat larger than the critical angle of the optical component 102/medium 152 interface. In this way, a substantial part of the radiation coupled into the optical component 102 reaches the detector, for all dipole orientations. The other half typically propagates essentially parallel with the second surface 112. A substantial part of the luminescence of the at least one sample 108 that has been coupled in the optical component 102 may be at least 40% of the luminescence entered in the at least one the optical component, preferably at least 45% of the luminescence entered in the at least one optical component, more preferably at least 50% of the luminescence entered in the at least one optical component. The emission of the at least one sample may for example be such that a substantial part of the luminescence coupled into the optical component 102 is emitted under an angle α with respect to the normal to the first surface 104, i.e. the optical component/medium interface, which is e.g. the case for dipole emission in an out-of-plane orientation as can be seen in FIG. 4. The second surface of the at least one optical component then typically preferably may make an angle with the first surface that is somewhat larger, e.g. δ°, than the angle into where most of the dipole irradiation is directed. The angle β thus may be e.g. an angle α+δ that is larger than the angle α, e.g. that is between 5° and 35° larger than the angle α, e.g. that is between 10° and 30° larger than the angle α, e.g. that is between 15° and 25° larger than the angle α, e.g. that is about 20° larger than the angle α. From FIG. 4, it can be concluded that for dipole orientations ranging from in-plane to out-of-plane orientation a substantial part of the radiation is between angles essentially normal to the first surface 104 (for in-plane orientation of the dipole) up to angles slightly larger than the total internal reflection angle at the interface between the first surface 104 and the medium 152. By a proper choice of the angle δ, e.g. between 10° and 30° such as e.g. between 15° and 25°, e.g. around 20°, one gets an arrangement such that about 50% of the emission radiated into the optical component 102 is directed towards the detecting element 110. If, for example, element 102 has an index of refraction slightly higher than 1.881 and the medium (e.g. water) has an index of refraction of 1.33, a substantial fraction of the radiation is between angles of −45 to +45 degrees with respect to the normal of the first surface 104. By choosing an angle δ of 20° about 50% of the emission radiated into the optical component 102 is directed towards the detecting element 110 having angles (with respect to the normal of the second surface 112) in the range 0 to 65 degrees.

By taken into account the dominant radiation direction of the radiation coupled in into the optical component for deciding the geometry of the optical component, at least a part of the luminescence may be incident to the detector element away from the critical angle, thus resulting in an increased detection efficiency.

In a third embodiment according to the first aspect, the present invention relates to a detection system as described in any of the above embodiments, comprising the same features and same advantages, but wherein furthermore additional optical elements are provided in order to increase the detection efficiency. Typically such additional features comprise a reflector either for directing part of the luminescence not directly detected by the detector element to the detector element or for redirecting excitation radiation to the first surface for at least a second time. An example of part of such a detection system is shown by way of illustration only in FIG. 6. FIG. 6 shows a detection system 200, e.g. prism, with a third surface 202, e.g. a second hypotenuse, having the same angle β with respect to the second surface 112 as the first surface 104, e.g. the first hypotenuse. The third surface 202 thereby is provided with a reflector 204 to reflect the emission B which is incident on the third surface 202 substantially parallel to the second surface 112, e.g. base, to that second surface 112. In order to substantially suppress excitation radiation reflected at the first surface 104 and directed towards detector element 110, typically the reflector 204 is a dichroic reflector, substantially not reflecting radiation having the same wavelength as the excitation radiation, e.g. the excitation radiation itself, to the at least one detector element 110. In the present example, the detecting device 200 thus is adapted for directing luminescence radiation to the at least one detector element 110 by orienting a third surface 202 of the at least one optical component 102 such that incident luminescent radiation B is reflected in the direction of the at least one detector element 110 and by providing a reflector 204, preferably a dichroic reflector. Such a reflector 204 may e.g. be obtained by coating the third surface 202 of the at least one optical component 102 with a reflecting layer or stack of layers, by providing a reflecting film to the third surface 202 or by attaching a reflecting element to the third surface 202 of the at least one optical component 102. The specific coating or material used typically will depend on the excitation wavelength(s) used and the luminescence wavelength(s) obtained. Alternatively, the additional optical element may be adapted for redirecting the excitation radiation towards the first surface 104 of the at least one optical component 102, as shown by way of example in the detection system 220 of FIG. 7. A reflector is provided adapted for reflecting excitation irradiation at a third surface 202 and the third surface 202, receiving excitation irradiation after reflection at the first surface 104 is oriented such that the excitation irradiation is reflected under an appropriate angle to the first surface 104 of the at least one optical component 102.

In a fourth embodiment according to the first aspect, the present invention relates to a detection system as described above, e.g. in any of the above embodiments, comprising the same features and the same advantages, but wherein the at least one optical component 102 is a plurality of optical components. The latter is illustrated by way of example in FIG. 8. The plurality of optical components may e.g. be a plurality of prisms. The plurality of prisms may e.g. be a one dimensional or two dimensional array of prisms. In this case optionally a reflector or non-transparent material, adapted to reflect or absorb the excitation radiation, may be applied at sides of the prisms where there is no binding of luminescent particles in order to avoid cross-talk. The excitation light or fluorescence at a first prism may be partly coupled to a second prism and there be considered as cross-talk. Using a reflector is preferred over using a non-transparent coating, because a reflector also improves the detection efficiency, as shown in FIG. 7. Furthermore, optionally also a double coating may be applied to prevent generated luminescence to be coupled in to a neighboring optical component. Again a reflector or non-transparent material may be used but applying a reflector for the generated luminescence may allow to redirect the luminescence towards the optical component and may provide a possibility that the luminescence is coupled in into the optical component and detected.

In other words, light shields can be applied to shield light from neighboring luminescent particles, positioned freely in the sample or immobilized at binding sites, e.g. to prevent cross-talk between different luminescent particles. The light shields can be combined with the use of the detector to provide detectors aligned with the sites for the spots, or independently of this.

Each optical component of the plurality of optical components may be used in combination with a single detector element, a number of optical components may be used with a combined detector element or a number of detector elements may be used in combination with each of the optical components.

The plurality of optical components may be positioned such that a surface of each of each of the optical components is parallel to a common plane. The plurality of optical components may receive the excitation radiation substantially perpendicular to that plane. The above may result in a simultaneous and/or uniform irradiation. Typically, the detection surface of the different detectors may be parallel to the plane and positioned at the same surface as the surface at which the excitation radiation is received. In this way, the excitation radiation and luminescence radiation can be separated substantially easy, resulting in a low signal to noise ratio.

In a further embodiment, the present invention relates to a detection system as described above, comprising the same features and the same advantages as described above, but wherein furthermore the detection system is an integrated device. In other words, the detection system or at least the detector elements are provided using large-area electronics technologies, such as e.g. based on integrated semiconductor processes or, more preferably, using active matrix technology or other integrated detector technologies, to suit the sensitivity needed for the application, or to suit other considerations such as cost, speed of detection, ruggedness and so on. Typically amorphous silicon (a-Si:H), e.g. a-Si on glass, low-temperature poly-silicon (LTPS) or organic technologies may be applied. Traditional large area electronics (LAE) technology offers electronic functions on glass which is cheap substrate and has the advantage for optical detection of being transparent. Active LAE poly-Si or a-Si substrates are proposed for this application, to detect which sample spots are emitting without the use of external photo-detectors. Standard LAE technology can be used integrating (at little or no extra costs) photo-diode or photo-TFT detectors together with the usual addressing TFTs and circuitry. Some embodiments can have a-Si photodiodes (or photo TFTs) integrated on the substrate.

A TFT, diode or MIM (metal-insulator-metal) could be used as active element. The active matrix technology is used in the field of flat panel displays for the drive of many display effects e.g. LCD, OLED and electrophoretic displays. It provides a cost-effective method to fabricate a disposable biochemical module. This is advantageous, as biochips, or alike systems, may contain a multiplicity of components, the number of which will only increase as the devices become more effective and more versatile. The detector can e.g. be implemented integrated in an active plate comprising both n- and p-type thin film transistors (TFTs). This can be part of a basic array comprising an active matrix of addressing transistors and storage capacitors in conjunction with a detector The capacitor allows the light to be integrated over a long frame period time period and then read out. This also allows other circuitry to be added (such as the integration of the drive, charge integration, and read-out circuitry). The detectors can simply be thin film transistors (TFTs) which are biased using a control electrode, e.g. gate-biased, in the off-state, or lateral diodes made in the same thin semiconductor film as the TFTs, or vertical diodes formed from a second, thicker, semiconductor layer. If TFTs or lateral diodes are to be used as the photo detectors, then these come at no extra cost. However, for good sensitivity vertical a-Si:H NIP diodes can be used, and these need to be integrated into the addressing TFTs and circuitry. Such a scheme has already been implemented both in a-Si:H TFT technology.

The optical components typically may be incorporated in the detection device by e.g. gluing or bonding such as vacuum bonding one or more optical components such as prisms, e.g. an array of optical components, to the surface of the substrate wherein/whereon the detector elements are provided. The latter typically may be performed, after the surface of the detection device has been provided with a planarisation layer for flattening the surface to which the optical components are connected. Another alternative to incorporate the reflector elements may be by gluing or bonding such as vacuum bonding, a layer or plate of transparent material such as e.g. glass or organic polymer material, to the surface of the substrate wherein/whereon the detector elements are provided. The layer or plate then may be processed, such as for example but not limited to by etching or laser processing, in order to form the optical components, e.g. prisms, therein. Alternatively, the layer or plate may already be processed in advance.

In a second aspect, the present invention also relates to a method for manufacturing a detection system as described in embodiments of the first aspect. A method of manufacture has the steps of forming the optical component or optical components and forming the detector or detectors on the optical components. The optical components and the detectors can be formed in and on a common substrate. Typically, such a method thus comprises providing at least one optical component having a first surface adapted for binding particles thereto and providing at least one detector element in direct contact with the at least one optical component. In direct contact thereby means that no low refractive index layer, such as e.g. an air layer is present between the detector element and the optical component. Typically for manufacturing the detector element in a substrate use may be made of large-area electronic technologies. The latter implies that the detector elements can be based on active matrix technology or other integrated detector technologies, to suit the sensitivity needed for the application, or to suit other considerations such as cost, speed of detection, ruggedness and so on. Typically amorphous silicon (a-Si:H), e.g. a-Si on glass, low-temperature poly-silicon (LTPS) or organic technologies may be applied. Traditional large area electronics (LAE) technology offers electronic functions on glass which is cheap substrate and has the advantage for optical detection of being transparent.

It is an advantage of embodiments according to the present invention that detection through the optical component generating the evanescent excitation field is applied, thus allowing to avoid the need for using an additional cover plate. Typically such cover plates imply that the maximum allowable emission angles that can be detected from the sample are severely limited due to total internal reflection of the luminescence leading to luminescence not coupled in to the cover plate or luminescence captured in the cover plate. Embodiments according to the present invention do not suffer from this problem.

It is an advantage of particular embodiments of the present invention that an easy scheme for evanescent field excitation of luminescence particles, e.g. fluorescent labeled particles, are obtained. The proposed schemes can provide in some cases simpler arrangements for the excitation (compared to known arrangements).

It is also an advantage of particular embodiments of the present invention that integrated detectors can be used, such as e.g. detectors based on active matrix technology commonly used in displays. The latter typically may increase the detection efficiency because the negative effects from total internal reflection at interfaces in the detection path can be reduced.

Other arrangements for accomplishing the objectives of the detection methods and systems embodying the invention will be obvious for those skilled in the art.

It is to be understood that although preferred embodiments, specific constructions and configurations, as well as materials, have been discussed herein for devices according to the present invention, various changes or modifications in form and detail may be made without departing from the scope and spirit of this invention. For example, whereas in the above description detection systems are described, the present invention also relates to a method for detecting biological, chemical or bio-chemical particles. The method thereby typically comprises providing at least one sample to an external surface of at least one optical component, e.g. a prism. Typically the latter is done by bringing sample or liquidized sample into contact with a surface of the at least one optical component and binding target particles of the sample to the surface, whereby the target particles typically may have luminescence capacity, e.g. they may be labeled using excitable fluorescent labels. An alternatively example to provide a sample may be bringing the sample in close contact with the external surface of the at least one component, e.g. by guiding sample along the external surface. Once at least one sample is provided, an evanescent excitation field may be generated outside the optical component near the external surface in order to excite the sample and thus generate luminescence. Such generation of an evanescent excitation field may be performed by bringing an excitation beam in total internal reflection in the at least one optical component. The generated luminescence from the excited sample is collected through the optical component, i.e. the luminescence from the at least one sample is coupled in into the at least one optical component and collected in a detector element. The detector element thereby is in direct contact with the at least one optical component. The latter allows a larger detection efficiency. The orientation of the surfaces of the optical component and the position of detection may be adapted to optimize detection of the emission of the at least one sample.

1. A detection system (100, 150, 180, 200, 220, 250) for detecting luminescence from at least one sample (108) when excited by incident excitation radiation, the detection system (100, 150, 180, 200, 220, 250) comprising at least one optical component (102) with at least a first surface (104) and at least one detector element (110), wherein
the first surface (104) of the at least one optical component (102) is located to totally internally reflect incident excitation radiation to create an evanescent field outside the at least one optical component (102) for exciting the at least one sample (108), and
the at least one detector element (110) is in direct contact with said at least one optical component (102) to detect the luminescence from at least one excited sample (108) through the at least one optical component (102).

2. An detection system (100, 150, 180, 200, 220, 250) according to claim 1, wherein the at least one optical component (102) is a prism.

3. An detection system (100, 150, 180, 200, 220, 250) according to claim 1, wherein the at least one detector element (110) is in direct contact with a second surface (112) of the at least one optical component (102), the angle between the first surface (104) and the second surface (112) of the at least one optical component (102) being adapted to a dominant luminescence radiation direction of the radiation of the at least one sample (108) coupled in into the optical component (102) as to receive a substantial part of the luminescence of the at least one sample (108) entered in the at least one optical component (102) in said detector element (110).

4. An detection system (100, 150, 180, 200, 220, 250) according to claim 3, wherein said emission pattern of said at least one sample (108) is such that a substantial part of said luminescence is emitted under substantially an angle α with respect to the normal to the first surface (104), said second surface (112) of said at least one optical component (102) making an angle with said first surface (104) that is larger than the angle α.

5. An detection system (100, 150, 180, 200, 220, 250) according to claim 3, wherein the second surface (112) is the surface through which the excitation radiation is coupled into the optical component (102).

6. An detection system (100, 150, 180, 200, 220, 250) according to claim 1, wherein the at least one optical component (102) is arranged with respect to the sample and consists of a material having a refractive index such that more than 50% of the luminescence to be coupled into the at least one optical component (102).

7. An detection system (250) according to claim 1, wherein the at least one detector (110) comprises an array of detector elements (110).

8. An detection system (100, 150, 180, 200, 220, 250) according to claim 1, the at least one optical component (102) comprises a plurality of optical components, each of the plurality of optical components adapted for receiving luminescence of at least one sample (108).

9. An detection system (100, 150, 180, 200, 220, 250) according to claim 7, wherein said plurality of optical components (102) are arranged such that a surface of each of said optical components (102) is parallel to a same plane and such that said optical components (102) receive said excitation radiation substantially perpendicular to said plane.

10. An detection system (100, 250) according to claim 8, wherein said at least one detector element (110) comprises a plurality of detector elements (110), a detection surface thereof being parallel to a same plane and being at a same side of the optical components (102) as a side from which the excitation radiation is received in the optical components (102).

11. An detection system (100, 150, 180, 200, 220, 250) according to claim 1, wherein the detection system furthermore comprises a surface adapted for reflecting luminescence from the at least one excited sample (108) coupled in said optical component (102) towards said at least one detector element (110).

12. An detection system (220) according to claim 1, the detection system comprising furthermore a reflector (220) to reflect the incident illumination after it has passed through the optical component, back into the optical component (102).

13. A detection system (100, 150, 180, 200, 220, 250) according to claim 1, wherein said detection system is an integrated device based on large-area electronics technologies.

14. A detection system (100, 150, 180, 200, 220, 250) according to claim 1, said detection system (100, 150, 180, 200, 220, 250) furthermore comprising an irradiation source (114) for generating excitation radiation.

15. A method for detecting luminescence from at least one sample, the method comprising:
providing at least one sample (108) to an external surface of at least one optical component (102)
creating an evanescent excitation field outside said at least one optical component (102) near said external surface to excite the at least one sample (108)
detecting luminescence from said at least one sample (108) coupled in said at least one optical component (102) and collected in at least one detector element (110) in direct contact with said optical component (102).

16. A method for detecting luminescence according to claim 15, wherein collecting said luminescence in at least one detector element (110) comprises collecting said luminescence at a position adapted to a dominant emission direction of radiation of the at least one sample (108) coupled into the optical component (102).
